(19) United States
(12) Patent Application Publication
(10) Pub. No.: US 2009/0065649 A1
(43) Pub. Date: Mar. 12, 2009

(54) STEERING OF VEHICLES THROUGH BOUNDARY LAYER CONTROL

(76) Inventors: Holger Babinsky, Cambridge (GB); Geoffrey Hatton, Peterborough (GB); Simon McIntosh, Cambridge (GB)

Correspondence Address: Fleit Gibbons Gutman Bongini & Bianco PL, 21355 EAST DIXIE HIGHWAY, SUITE 115, MIAMI, FL, 33180, US

(21) Appl. No.: 11/909,515

(22) PCT Filed: Mar. 23, 2006
(86) PCT No.: PCT/GB2006/050065

§ 371 Date: Sep. 24, 2007

(30) Foreign Application Priority Data
Mar. 23, 2005 (GB) 0505957.1

(51) Int. Cl. B64C 21/00

(52) U.S. Cl. 244/204

(57) ABSTRACT

In aeronautical devices where a fluid such as air flows over a surface (1) to create lift or thrust, improved performance can be obtained by energising a so-called 5 “boundary layer” (10) of the fluid flow close to the surface. This is known to help prevent separation of the fluid flow stream from the surface thereby maximising the lift or thrust achieved. The invention provides a facility (7A) for controlling the mechanisms (7) used for energising the boundary layer so as to selectively increase or decrease the effect 10 in different areas. When this is done for example on different sides of an air vehicle, it provides an effective mechanism for steering the vehicle.

This invention relates to the steering of vehicles. The invention arose in connection with the design of a vertical take-off aircraft which uses the Coanda effect to create lift.

The Coanda effect is a phenomenon which tends to keep a jet of fluid attached to a surface over which it flows. If the surface is curved, this will result in a change in the direction of the jet thereby producing a desired thrust.

In an arrangement such as described above it is important to minimise drag and the surface should therefore be shaped so as to achieve the desired angular diversion of the jet over a minimum surface area. This calls for the minimum radius of curvature possible without causing the jet to separate from the surface. A so-called boundary layer always exists between a surface and a fluid flowing over it, forming an interface between the stationary surface and a main body of the moving fluid. It is well known that separation of the jet from the surface can be prevented by energising this boundary layer. This can be done by inducing tiny vortices in the boundary layer or by injecting into it an extra stream of fluid in the direction of the main flow. These and other boundary layer energisation techniques are used on aircraft wings to help the airflow to “stick” to them.

The invention provides a vehicle comprising an impeller for causing fluid to flow over a surface of the vehicle thereby producing lift or thrust, an intervention mechanism for energising a boundary layer of the fluid thereby causing the flow to remain attached to the surface and a steering mechanism for steering the vehicle; characterised in that the steering mechanism operates by controlling the intervention mechanism.

Thus the invention recognises that, if the intervention mechanism is controllable, it can be used for steering the vehicle. For example, if an intervention mechanism is de-activated on one side of the vehicle, that side will lose lift and turn towards the other side. The principle could be used on vehicles where the flow over the surface is caused by movement of the vehicle as in a conventional aircraft, boat or submarine. However it is envisaged that the principal application of the invention will be in arrangements where the impeller generates a jet of fluid and directs it over the surface, and more particularly an arrangement where the surface is a dome-shaped canopy and the impeller directs an annular jet from a central part of the dome, radially outwardly towards its outer edge.

The “intervention mechanism” can take many possible forms. One possibility would be to blow pulses of fluid from minute holes in the surface. This could be achieved using an electrically actuated diaphragm associated with each cavity. Another possibility would be to use slots in the surface, controlled by vanes so as to select whether additional air is injected into the boundary layer.

Particular embodiments of the invention will now be described by way of example with reference to the accompanying drawings in which:—

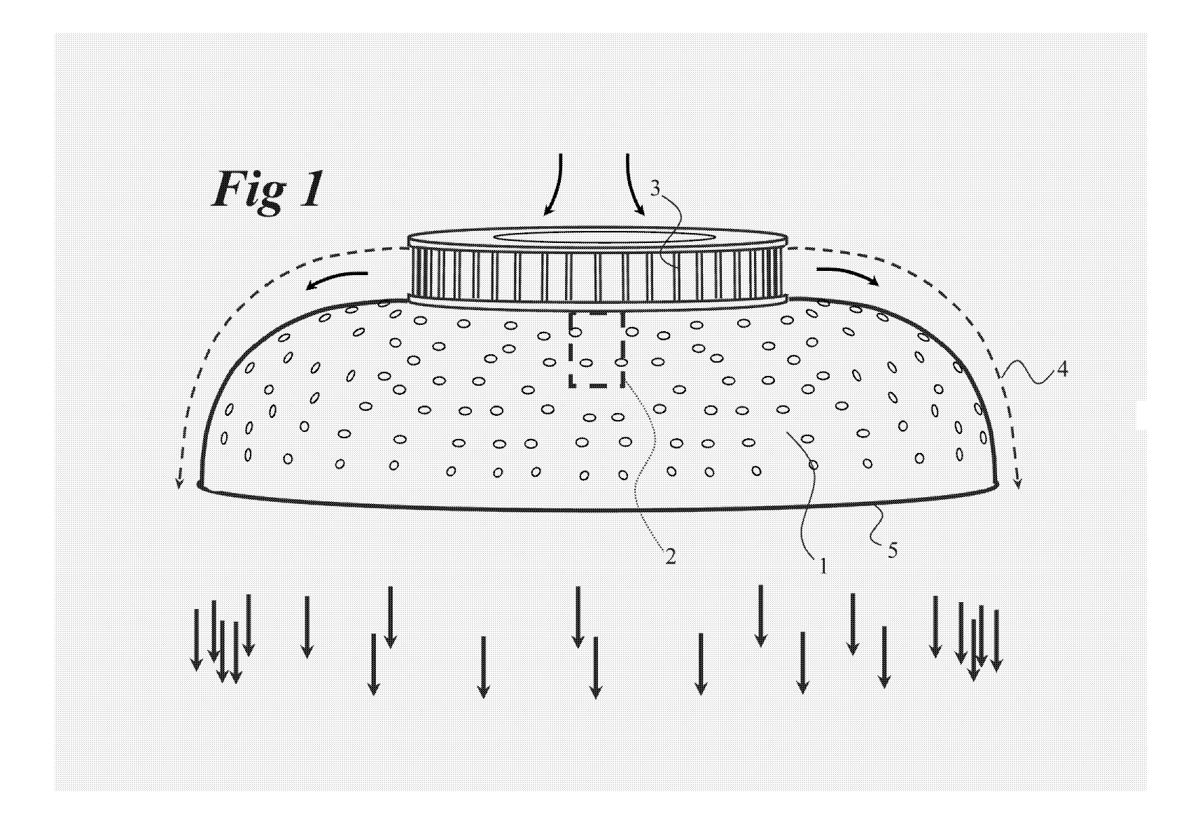

FIG. 1 is a schematic perspective view of a vertical take-off air vehicle constructed in accordance with the invention;

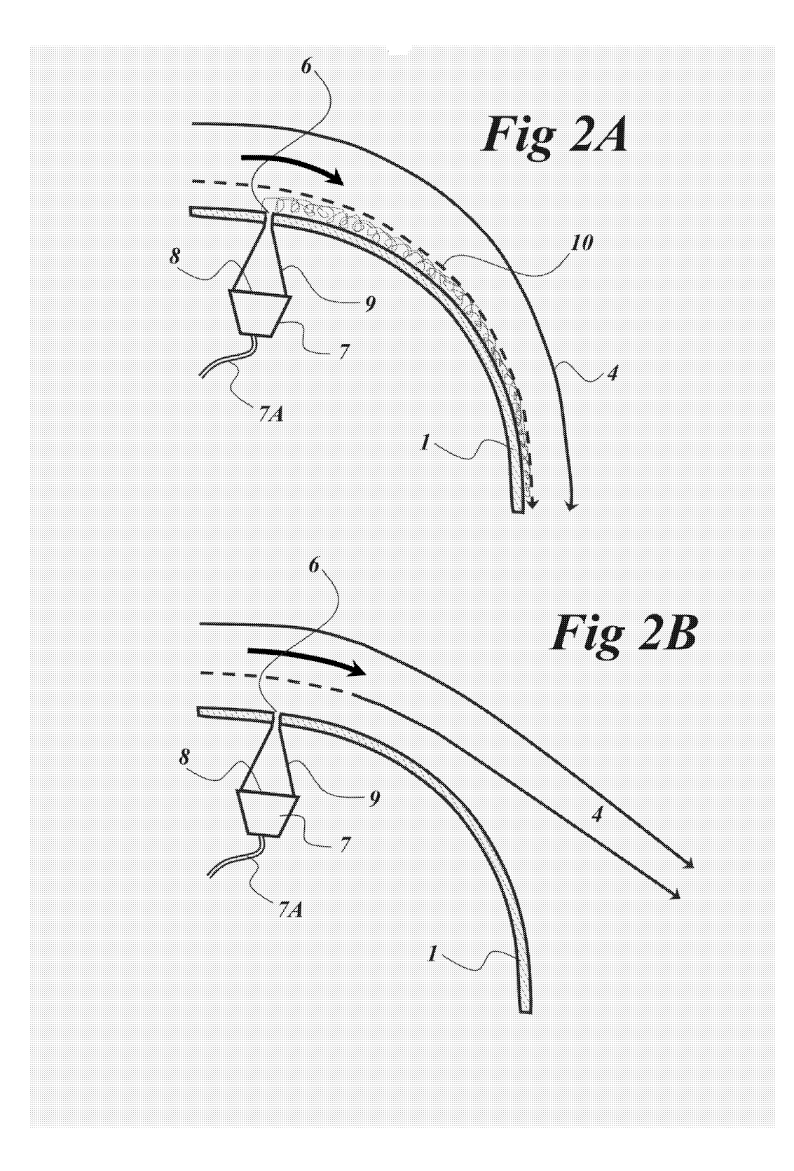

FIG. 2A is a detailed cross-section through one of a number of boundary layer energisers of the vehicle of FIG. 1;

FIG. 2B is similar to FIG. 2A but showing the energiser switched off;

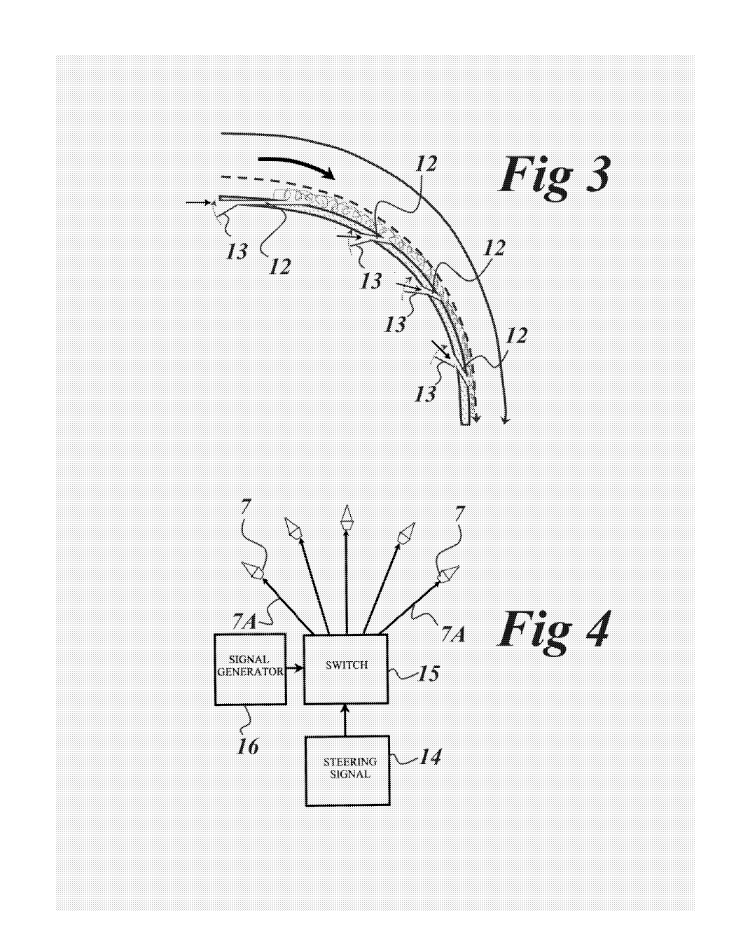

FIG. 3 is similar to FIG. 2A but showing an alternative method of boundary layer energisation;

And FIG. 4 illustrates schematically a control system for use with the embodiment of FIGS. 1 & 2.

Referring to FIG. 1, the illustrated aircraft comprises a dome-shaped canopy 1 supporting an engine 2 which in this particular embodiment is an electric motor. The motor 2 drives an axial fan 3 which propels air radially from a circular outlet slot 4. The resulting radially flowing jet of air flows over the canopy 1 and is kept in contact with it by the Coanda effect until it reaches a bottom edge 5 where it becomes detached, forming a near-vertical annular jet. The downward momentum of this jet results in an equal upward momentum transferred to the aircraft.

The jet 4 of air exists in a so-called “bi-stable” condition such that it will remain in contact with the curved surface but, if caused to detach, will remain detached. The curve of the surface is carefully chosen so that the jet is in this bi-stable condition over all parts of the surface at the normal operating speed of the impeller 3 and when boundary layer energisation, now to be described, is switched on. Distributed over the surface are a large number of tiny holes 6 through which vibrating pulses of air are generated. These pulses serve to energise a boundary layer allowing the curve of the surface 1 to have a smaller radius than would be possible without such boundary layer energisation. The theory of such boundary layer control is well known, being described for example in the text book “Mechanics of Fluids” by Bernard Massey published 1998 by Stanley Thorns (publishers) Ltd.

FIG. 2A shows how the pulses of air are generated using an energiser 7. The energiser is fed with a square wave electrical signal on line 7A to drive a diaphragm 8 similar in construction to an earphone or loudspeaker. The diaphragm 8 forms one wall of a cavity 9 which projects through the canopy surface to define the aperture 6. Because the aperture 6 is small compared with the diaphragm 8 a much larger air movement is achieved at point 6 than the movement of the diaphragm itself. The boundary layer, indicated by the broken line 10, is energised by the resulting pulses of air which cause vortices downstream of point 6, ensuring that the main stream 4 of the jet remains attached to the surface.

If the pulsing signal applied to the energiser 7 is switched off, a situation is produced as shown in FIG. 2B where, because of the lack of boundary layer energization, the jet detaches at point 11 from the surface 1.

FIG. 3 shows an alternative method of boundary layer energization in which a positive pressure is produced inside the canopy. Slots 12 allow this air to be injected into the boundary layer to produce the required energisation, which may or may not include the generation of vortices. Control vanes 13 can be closed under the control of a steering signal. This obstructs the flow of air through the slots 12, causing detachment of the jet.

FIG. 4 shows a control system for producing the control signals on lines 7A. A steering signal is produced at 14 indicating a desired pitch or roll of the craft. This signal is used to control a switch 15. In normal operation, a signal generator 16 feeds square wave signals, through the switch 15 to all of the lines 7A. A steering signal from block 14 will interrupt the signals fed to selected lines 7A, causing the jet to be detached from the surface of the canopy 1 at any desired position, causing the craft to move away from that position.

1. A vehicle comprising an impeller for causing fluid to flow over a surface of the vehicle thereby producing lift or thrust, an intervention mechanism for energising a boundary layer of the fluid thereby causing the flow to remain attached to the surface and a steering mechanism for steering the vehicle; characterised in that the steering mechanism operates by controlling the intervention mechanism.

2. A vehicle according to claim 1 in which the intervention mechanism includes a diaphragm and in which the steering mechanism includes means for causing vibration of the diaphragm.

3. A vehicle according to claim 2 in which the diaphragm defines a wall of a cavity which opens onto the surface, the opening being smaller than the diaphragm.

4. A vehicle according to claim 1 in which the intervention mechanism comprises at least one opening in the surface and in which the steering mechanism is designed to control a flow of fluid through the opening.

5. A vehicle according to claim 4 in which the opening is a slot.

6. A vehicle according to claim 1 in which the intervention mechanism is a vortex generator.

7. A vehicle according to claim 1 in which the vortex generator is of variable geometry.

8. A vehicle according to claim 1 including a series of intervention mechanisms extending from a position upstream of where separation would occur without intervention to a position downstream of that position.

9. A vehicle according to claim 1 in which the surface is dome-shaped and in which the impeller is arranged to drive a jet of fluid radially outwardly over the surface.
